(19) United States
(12) Patent Application Publication
(10) Pub. No.: US 2013/0330615 A1
(43) Pub. Date: Dec. 12, 2013

(54) LITHIUM-ION SECONDARY BATTERY AND METHOD FOR MANUFACTURING THE SAME

(71) Applicants: Masahiro Morita, Nisshin-shi (JP); Yutaka Oyama, Toyota-shi (JP)

(72) Inventors: Masahiro Morita, Nisshin-shi (JP); Yutaka Oyama, Toyota-shi (JP)

(21) Appl. No.: 13/985,326

(22) PCT Filed: Feb. 16, 2011
(86) PCT No.: PCT/JP2011/053295

§ 371 Date: Aug. 14, 2013

(51) Int. Cl. H01M 4/13

(52) U.S. Cl. CPC H01M 4/13
USPC 429/211; 29/623.5

(57) ABSTRACT

A lithium-ion secondary battery is provided which has a positive electrode formed using a composition formed of an aqueous solvent and which exhibits superior battery performance. The battery comprises a positive electrode and a negative electrode, and the positive electrode has a positive electrode current collector and a positive electrode mixture layer which is formed on the current collector and which includes at least a positive electrode active material and a hinder. A surface of the positive electrode active material is coated by a hydrophobic coating and the binder dissolves or disperses in the aqueous solvent.

### TECHNICAL FIELD

The present invention relates to a lithium-ion secondary battery and a method for manufacturing the same. More specifically, the present invention relates to a positive electrode configured such that positive electrode materials including a positive electrode active material are retained on a positive electrode current collector and to a method of manufacturing a lithium-ion secondary battery having the positive electrode.

### BACKGROUND ART

Since lithium-ion secondary batteries which are charged and discharged by migration of lithium ions between a positive electrode and a negative electrode are lightweight and capable of producing high energy density, they are growing in importance as, for example, power supplies mounted to vehicles which use electricity as a drive source and as power supplies for personal computers, mobile phones, and other electric products.

A lithium-ion secondary battery with a typical configuration comprises an electrode constructed such that electrode materials mainly constituted by a material capable of reversibly storing and releasing lithium ions (an electrode active material) are formed in layers on an electrically conductive member (an electrode current collector) (hereinafter, such a layered formation will be referred to as an “electrode mixture layer”). For example, in the case of a positive electrode, a positive electrode mixture layer is formed by preparing a paste-like composition (paste-like compositions include a slurry composition and an ink-like composition) obtained by dispersing and kneading a lithium-containing compound as a positive electrode active material, a powder of a highly-conducting material (an electrically conductive material), a binder, and the like in an appropriate solvent, applying the paste-like composition on a positive electrode current collector (for example, an aluminum material), and drying the paste-like composition. Prior art related to such positive electrodes includes Patent Literature 1 and 2.

### CITATION LIST

### Patent Literature

Patent Literature 1: Japanese Patent Application Publication No. 2009-193805

Patent Literature 2: Japanese Patent Application Publication No. H11-224664

### SUMMARY OF INVENTION

### Technical Problem

With the technique described in Patent Literature 1, an aqueous solvent (specifically, water) is adopted as a solvent used when preparing a paste-like positive electrode mixture layer forming composition. However, the use of the aqueous solvent may result in elution of lithium ions from a lithium-containing compound (a positive electrode active material) into the solvent and cause the composition itself to exhibit a strong alkaline property. As described above, with an alkaline composition, there is a risk of decomposition of a binder contained in the composition, agglomeration (gelation) of the binder, or agglomeration of the positive electrode active material. Decomposition or agglomeration of such materials may reduce viscosity or adhesion of the paste-like composition and may further cause dispersibility to decline. Therefore, it may become difficult to form a positive electrode mixture layer with a uniform composition on a positive electrode current collector at a desired thickness. Uneven thickness or uneven composition causes battery responsiveness during charge and discharge to decline and may further cause an increase in internal resistance of a battery, and is therefore unfavorable.

On the other hand, compared to a case where an organic solvent (for example, N-methylpyrrolidone) is used, using an aqueous solvent advantageously includes needing smaller amounts of the organic solvent and ensuing industrial waste, and since no facility cost or processing cost is incurred, there is less environmental impact as a whole. In consideration of such advantages, a technique is required which involves the use of an environmentally-friendly aqueous solvent (typically, water) and which enables formation of a positive electrode mixture layer (and by extension, a positive electrode) with properties capable of realizing desired battery performance even when the aqueous solvent is used.

Accordingly, the present invention has been made in order to solve the conventional problems (demands) described above, and an object thereof is to provide a lithium-ion secondary battery which comprises a positive electrode formed using a composition including an aqueous solvent and which exhibits superior battery performance. Another object of the present invention is to provide a method of manufacturing a lithium-ion secondary battery including the positive electrode disclosed herein.

### Solution to Problem

In order to achieve the objects described above, the present invention provides a method of manufacturing a lithium-ion secondary battery. The method of manufacturing a lithium-ion secondary battery disclosed herein includes: a step of forming a positive electrode comprising a positive electrode mixture layer including a positive electrode active material on a positive electrode current collector; a step of forming a negative electrode having a negative electrode mixture layer including a negative electrode active material on a negative electrode current collector; and a step of combining the formed positive electrode and the formed negative electrode to form an electrode body. The positive electrode forming step includes: preparing a coated positive electrode active material by coating a surface of the positive electrode active material with a hydrophobic coating; preparing a paste-like positive electrode mixture layer forming composition resulting from adding at least the coated positive electrode active material and a binder, which dissolves or disperses into an aqueous solvent, to an aqueous solvent and kneading the same; and applying the prepared positive electrode mixture layer forming composition to a surface of the positive electrode current collector.

The method of manufacturing a lithium-ion secondary battery provided by the present invention involves the use of a coated positive electrode active material obtained by coating the surface of a positive electrode active material with a hydrophobic coating. Therefore, during preparation (formulation) of a paste-like positive electrode mixture layer forming composition, for example, even when a lithium transition metal complex oxide as the positive electrode active material and an aqueous solvent (for example, water) are used, elution of lithium in the positive electrode active material into the aqueous solvent as lithium ions can be suppressed. Accordingly, even if an aqueous solvent is used, the prepared composition does not exhibit a strong alkaline property, and decomposition or gelation of the binder, agglomeration of active materials, a reaction (such as an alkaline corrosion reaction) between the positive electrode current collector and the composition, and the like based on the strong alkaline property are prevented. Therefore, according to the present invention, a high-performance lithium-ion secondary battery can be manufactured which prevents an increase in reaction resistance and a decrease in endurance of a battery and which has a smaller environmental impact than conventional lithium-ion secondary batteries.

According to a preferable mode of the manufacturing method disclosed herein, an amphiphilic compound is used as the binder. With this configuration, since affinity between the hydrophobic coating of the coated positive electrode active material and the aqueous solvent (for example, water) increases via the amphiphilic compound, the active material and the binder disperse favorably in the positive electrode mixture layer forming composition. Polyethylene oxide is particularly favorably adopted as the amphiphilic compound.

According to another preferable mode of the manufacturing method disclosed herein, when (a total amount of) the formed positive electrode mixture layer is assumed to be 100% by mass, the paste-like positive electrode mixture layer forming composition is prepared so that the binder is included in the positive electrode mixture layer in a proportion of 2% by mass to 5% by mass. With this configuration, since the binder is included in the positive electrode mixture layer in an appropriate amount, a lithium-ion secondary battery with superior performance can be manufactured.

According to another preferable mode of the manufacturing method disclosed herein, a coated positive electrode active material obtained by coating a surface of the positive electrode active material with a water-repellent resin as the hydrophobic coating is used. Since the surface of the positive electrode active material is coated by a water repellent the positive electrode active material and the aqueous solvent can be prevented from coming into contact with each other. Favorably, the water-repellent resin is a fluorine-based resin. For example, since polyvinylidene fluoride has high ion permeability, a hydrophobic coating formed using polyvinylidene fluoride has low resistance.

According to another preferable mode of the manufacturing method disclosed herein, a coated positive electrode active material obtained by coating a surface of the positive electrode active material with a transition metal oxide as the hydrophobic coating is used. Since the surface of the positive electrode active material is coated by a transition metal oxide, the positive electrode active material and the aqueous solvent can he prevented from coming into contact with each other. Favorably, the transition metal oxide is tungsten oxide or zirconium oxide.

According to another preferable mode of the manufacturing method disclosed herein, when the positive electrode active material is assumed to have a BET specific surface area of X [m²/g] and A/B, which is a ratio between a mass A [mg] of a transition metal oxide that is the coating material and a mass B [g] of the positive electrode active material, is assumed to be an oxide-coated amount Y [mg/g], a coated positive electrode active material is used, where Y/X has a value of 5 mg/m² to 50 mg/m². When Y/X is within this range, since the positive electrode active material is sufficiently coated by the transition metal oxide and ion permeability of the transition metal oxide increases, a lithium-ion secondary battery with superior performance can be manufactured.

According to another preferable mode of the manufacturing method disclosed herein, as the positive electrode active material, a lithium-nickel complex oxide represented by the general formula:

Li₁₊ₓ(Ni_{y}Co_{z}Mn_{1-y-z-γ}M_{γ})O₂

(where 0≦x≦0.2, 0.5≦y≦1, 0≦z≦0.5, 0≦z≦0.5, 0≦γ≦0.2, 0.5≦y+z+γ≦1, and M is at least one element selected from the group including F, B, Al, W, Mo, Cr, Ta, Nb, V, Zr, Ti, and Y) is used.

While a positive electrode active material having a lithium-nickel complex oxide with a high nickel (Ni) compositional ratio as a main component has various favorable properties as a positive electrode active material of a lithium-ion secondary battery, nickel is characteristically sensitive to moisture and deteriorates easily. Therefore, the effect of adopting the configuration according to the present invention is particularly demonstrated.

In addition, as another aspect for achieving the objects described earlier, the present invention provides a lithium-ion secondary battery comprising a positive electrode and a negative electrode. Specifically, in a lithium-ion secondary battery disclosed herein, the positive electrode comprises a positive electrode current collector and a positive electrode mixture layer which is formed on the current collector and which includes at least a positive electrode active material and a binder. A surface of the positive electrode active material is coated by a hydrophobic coating and the binder dissolves or disperses in an aqueous solvent.

The lithium-ion secondary battery provided by the present invention comprises a positive electrode including a positive electrode active material whose surface is coated by a hydrophobic coating and a binder which dissolves or disperses in an aqueous solvent.

With this lithium-ion secondary battery, since the surface of the positive electrode active material is coated by a hydrophobic coating, contact between the positive electrode active material and moisture can be suppressed and the positive electrode active material is prevented from coming into contact with the aqueous solvent during a manufacturing process. In other words, a high-performance lithium-ion secondary battery is provided in which decomposition or gelation of the hinder, agglomeration of active materials, corrosion of the positive electrode current collector, and the like are prevented and which has reduced environmental impact.

According to a preferable mode of the lithium-ion secondary battery disclosed herein, the binder is an amphiphilic compound. Polyethylene oxide is particularly favorably adopted as the amphiphilic compound.

According to another preferable mode, when (a total amount of) the positive electrode mixture layer is assumed to be 100% by mass, the binder is included in the positive electrode mixture layer in a proportion of 2% by mass to 5% by mass. In addition, according to another preferable mode, the hydrophobic coating is formed of a water-repellent resin. Favorably, the water-repellent resin is a fluorine-based resin. In addition, according to another preferable mode, the hydrophobic coating is formed of a transition metal oxide. Favorably, the transition metal oxide is tungsten oxide or zirconium oxide.

According to another preferable mode, a surface of the positive electrode active material is coated by a hydrophobic coating constituted by the transition metal oxide, and when the positive electrode active material is assumed to have a BET specific surface area of X [m²/g and A/B, which is a ratio between a mass A [mg] of a transition metal oxide that is the coating material and a mass B [g] of the positive electrode active material, is assumed to be an oxide,-coated amount Y [mg/g], Y/X has a value of 5 mg/m² to 50 mg/m². According to another preferable mode, the positive electrode active material is a lithium-nickel complex oxide represented by the general formula:

Li₁₊ₓ(Ni_{y}Co_{z}Mn_{1-y-z-γ}M_{γ})O₂

(where 0≦x≦0.2, 0.5≦y≦1, 0≦z≦0.5, 0≦γ≦0.2, 0.5≦y+z+γ≦1, and M is at least one element selected from the group including F, B, Al, W, Mo, Cr, Ta, Nb, T, Zr, Ti, and Y),

With any of the lithium-ion secondary batteries disclosed herein or a lithium-ion secondary battery manufactured by any of the methods disclosed herein, since defects such as decomposition of a binder or the like are suppressed at the positive electrode as described above, superior battery performance (typically, improved cycling Characteristics) is demonstrated. Since the lithium-ion secondary battery produces superior battery performance as described above, the lithium-ion secondary battery is particularly favorably used as a motor (electric motor) power source to be mounted to a vehicle such as an automobile. Therefore, the present invention provides a vehicle (typically, an automobile, and more particularly an automobile comprising an electric motor such as a hybrid automobile, an electric automobile, and a fuel-cell powered automobile) comprising the secondary battery (or an assembled battery in which a plurality of the secondary batteries is connected in series) as a power source.

### BRIEF DESCRIPTION OF DRAWINGS

FIG. 1 is a perspective view schematically showing an external shape of a lithium-ion secondary battery according to an embodiment of the present invention;

FIG. 2 is a sectional view taken along line II-II in FIG. 1;

FIG. 3 is a sectional view schematically showing a structure of a positive electrode according to an embodiment of the present invention;

FIG. 4 is a graph showing a viscosity ratio of a paste-like composition prepared in a test example;

FIG. 5 is a graph showing a resistance ratio of a lithium-ion secondary battery constructed in a test example;

FIG. 6 is a graph showing a relationship between binder content and resistance ratio;

FIG. 7 is a graph showing a viscosity ratio of a paste-like composition prepared in another test example;

FIG. 8 is a graph showing a resistance ratio of a lithium-ion secondary battery constructed in another test example;

FIG. 9 is a graph showing a relationship between values of Y/X and resistance ratio of a lithium-ion secondary battery constructed in another test example; and

FIG. 10 is a side view schematically showing a vehicle (automobile) comprising a lithium-ion secondary battery according to an embodiment of the present invention.

### DESCRIPTION OF EMBODIMENTS

The following provides an explanation of preferred embodiments of the present invention. Matters required to carry out the present invention, with the exception of matters specifically mentioned in the present specification, can he understood to be design matters of a person with ordinary skill in the art based on the prior art in the relevant technical field. The present invention can be carried out based on the contents disclosed in the present specification and common general technical knowledge in the relevant field.

The lithium-ion secondary battery provided by the present invention characteristically comprises a positive electrode including a positive electrode active material (coated positive electrode active material) whose surface is coated by a hydrophobic coating and a binder which dissolves or disperses in an aqueous solvent.

Hereinafter, a method of manufacturing a lithium-icon secondary battery disclosed herein and a lithium-ion secondary battery manufactured by the manufacturing method will be described in detail.

The method of manufacturing a lithium-ion secondary battery disclosed herein comprises a coated positive electrode active material preparing step, a composition preparing step, and a composition applying step.

First, the coated positive electrode active material preparing step will be described. The coated positive electrode active material preparing step includes preparing a coated positive electrode active material which is created by coating a surface of a positive electrode active material by a hydrophobic coating.

The positive electrode active material used in the positive electrode of the lithium-ion secondary battery disclosed herein is a material capable of storing and releasing lithium ions and examples thereof include a lithium-containing compound (for example, a lithium transition metal complex oxide) containing lithium and one, two or more transition metal elements. Examples include ternary lithium-containing complex oxides such as a lithium-nickel complex oxide (for example, LiNiO₂), a lithium-cobalt complex oxide (for example, LiCoO₂), a lithium-manganese complex oxide (for example, LiMn₂O₄), and a lithium-nickel-cobalt-manganese complex oxide (for example, LiNi_{1/3}Co_{1/3}Mn_{1/3}O₂).

In addition, a polyanionic compound expressed by a general formula of LiMPO₄, LiMVO₄, or Li₂MSiO₄ (where M in the formula represents at least one or more element among Co, Ni, Mn, and Fe) (for example, LiFePO₄, LiMnPO₄, LiFeVO₄, LiMnVO₄, Li₂FeSiO₄, Li₂MnSiO₄, or Li₂CoSiO₄) may be used as the positive electrode active material.

In particular, application to a lithium-nickel complex oxide expressed by the general formula: Li₁₊ₓ(Ni_{y}CoₓMn_{1-y-z-γ}M_{γ})O₂ is favorable. In this case, in the formula, a value of x satisfies 0≦x≦0.2, a value of y satisfies 0.5≦y≦1, a value of z satisfies 0≦z≦0.5, a value of γ satisfies 0≦γ≦0.2, and 0.5≦y+z+γ≦1 is satisfied. In addition, examples of M include F, B, Al, W, Mo, Cr, Ta, Nb, V, Zr, Ti, Y, and the like. Among these elements, M is preferably one, two or more transition metal elements (in other words, on the periodic table, the 6th group (chromium group) elements W, Mo, and Cr, the 5th group (vanadium group) elements V, Nb, and Ta, the 4th group (titanium group) elements Ti and Zr, or the 3rd group element Y). The present invention can be particularly preferably applied when using such a lithium-nickel complex oxide with a high nickel (Ni) compositional ratio. Although nickel is characteristically sensitive to moisture and deteriorates easily, since the surface of the positive electrode active material is coated by a hydrophobic coating in the present invention, the positive electrode active material and an aqueous solvent (typically, water) can be prevented from coming into contact with each other. However, the present invention can be applied even when nickel is not included.

The positive electrode active material disclosed herein may be secondary particles (a granular powder formed by agglomeration of a large number of microparticles of the positive electrode active material) ranging from, for example, approximately 1 μm to 15 μm (for example, approximately 2 μm to 10 μm). Moreover, average particle diameters as used herein refer to median diameters (d50) which can be readily measured by various commercially-available particle size distribution analyzers based on a laser diffraction/laser scattering method.

Examples of the hydrophobic coating which coats the surface of the positive electrode active material disclosed herein include a water-repellent resin and a transition metal oxide.

First, a water-repellent resin which coats the surface of the positive electrode active material will be described. Examples of materials that constitute the water-repellent resin disclosed herein include fluorine-based resins. Particular examples are polyvinylidene fluoride-based resins with relatively high lithium-ion permeability (conductivity). A favorably used polyvinylidene fluoride-based resin is polyvinylidene fluoride (PVDF) produced by the polymerization of one vinylidene fluoride monomer. Alternatively, the polyvinylidene fluoride resin may be a copolymer with a vinylic monomer copolymerizable with vinylidene fluoride. Examples of vinylic monomers copolymerizable with vinylidene fluoride include hexafluoropropylene, tetrafluoroethylene, chlorotrifluoroethylene, and the like. Furthermore, a mixture of two or more of the homopolymers and copolymers described above can be adopted. Examples of other fluorine-based resins include polytetrafluoroethylene (PTFE), polyvinyl fluoride (PVF), and the like. In addition, a resin material such as polyacrylonitrile, polyamidimide, or the like can be used instead of a fluorine-based resin.

Next, a method of coating the surface of the positive electrode active material with a water-repellent resin will be described. A coated positive electrode active material in which the surface of the positive electrode active material is coated by a water-repellent resin can be obtained by preparing a paste-like mixture by dispersing and mixing the positive electrode active material and the water-repellent resin in an appropriate solvent and drying the paste-like mixture at an appropriate temperature (for example, approximately 100° C. to 180° C.). For example, kneading of the paste-like mixture can be performed using a planetary mixer.

The solvent used in the paste-like mixture described above may be an organic solvent such as N-methylpyrrolidone (NMP), pyrrolidone, methyl ethyl ketone, methyl isobutyl ketone, cyclohexanone, toluene, dimethylformamide, and dimethylacetamide, or a combination of two or more of these organic solvents. Alternatively, water or an aqueous solvent mainly constituted by water may be used. As a solvent other than water which constitutes such an aqueous solvent, one, two or more organic solvents (lower alcohol, lower ketone, or the like) which can be homogeneously mixed with water can be appropriately selected and used. A solid content concentration (a non-volatile content or, in other words, a combined proportion of the positive electrode active material and the water-repellent resin) of the paste-like mixture is favorably approximately 20% by mass to 70% by mass.

When the average particle diameter (median diameter: d50) of the positive electrode active material is assumed to be C [μm], a mass thereof is assumed to be D [g], and a mass of the water-repellent resin coating the surface of the positive electrode active material is assumed to be E [g], a relational expression of 0.05≦C×(E/D)≦0.20 is favorably satisfied. A value smaller than 0.05 means that the surface of the positive electrode active material is not sufficiently coated and there is a risk that contact with the aqueous solvent cannot be suppressed. On the other hand, a value larger than 0.20 means that an excessive decline in ion permeability of the water-repellent resin may increase resistance.

Next, a transition metal oxide which coats the surface of the positive electrode active material will be described. A transition metal element that constitutes the transition metal oxide disclosed herein is not particularly limited. Examples of transition metal elements include tungsten (W), molybdenum (Mo), chromium (Cr), niobium (Nb), vanadium (V), tantalum (Ta), titanium (Ti), zirconium (Zr), iron (Fe) and copper (Cu). In particular, tungsten oxide (WO₃) including tungsten as a structural element, zirconium oxide (ZrO₂) including zirconium as a structural element, and the like can be favorably used.

Next, a method of coating the surface of the positive electrode active material with a transition metal oxide will be described. An exemplary method involves mixing the positive electrode active material with a powder of the transition metal oxide and applying a mechanochemical process to the materials. In this case, a “mechanochemical process” refers to applying mechanical energy such as a compressive force, a shear force, or a frictional force to processed objects (in this case, the positive electrode active material and the transition metal oxide) in order to physically (mechanically) join (combine) the processed objects with each other. Moreover, a device for applying the mechanochemical process need only apply mechanical energy such as a shear force to the positive electrode active material and the transition metal oxide and is not particularly limited. Examples of such devices include a bench-top ball mill, a planetary ball mill, a bead mill, a dispersion mixer, and a powder mixer.

As another method, a coated positive electrode active material in which the surface of the positive electrode active material is coated by a transition metal oxide can be obtained by removing (for example, by evaporation) a solvent including a metallic alkoxide soluble in water or alcohol from a mixed material obtained by kneading the solvent with the positive electrode active material and heating the mixed material from which alcohol has been removed under appropriate heating conditions (for example, 200° C. to 700° C.). Examples of the metallic alkoxide include tungsten ethoxide and zirconium butoxide.

When the positive electrode active material is assumed to have a BET specific surface area of X [m²/g] and A/B, which is a ratio between a mass A [mg] of a transition metal oxide that is the coating material and a mass B [g] of the positive electrode active material, is assumed to be an oxide-coated amount Y [mg/g], a value of Y/X favorably ranges from approximately 5 mg/m² to 50 mg/m² (more favorably ranges from approximately 10 mg/m² to 40 mg/m²). A value of Y/X that is smaller than 5 mg/m² means that the surface of the positive electrode active material is not sufficiently coated and there is a risk that contact with the aqueous solvent cannot be suppressed. On the other hand, a value of Y/X that is larger than 50 mg/m² means that an excessive decline in ion permeability of the water-repellent resin may increase resistance. Moreover, a value measured in accordance with JIS K1477 (JIS Z 8830) is to be adopted as the BET specific surface area.

Next, the composition preparing step will be described. The composition preparing step involves preparing a paste-like positive electrode mixture layer forming composition (hereinafter, sometimes also simply referred to as a “composition”) by adding at least the coated positive electrode active material prepared in the step described above and a binder which dissolves or disperses in an aqueous solvent to an aqueous solvent and kneading the aqueous solvent.

Since an aqueous solvent is used when preparing the composition, a binder used for the positive electrode of the lithium-ion secondary battery disclosed herein is not particularly limited as long as the binder dissolves or disperses in the aqueous solvent. Examples of binders include: cellulose-based polymers such as carboxymethyl cellulose (CMC), methyl cellulose (MC), and cellulose acetate phthalate (CAP); polyvinyl alcohol (PVA); fluorine-based resins such as polyethylene oxide (PEO), polytetrafluoroethylene (PTFE), and polyvinylidene fluoride (PVDF); vinyl acetate copolymers; and alkyltrimethylammonium salts. In particular, an amphiphilic compound such as polyethylene oxide or an alkyltrimethylammonium salt can be favorably used. Furthermore, polyethylene oxide with a mass-average molecular weight of 500,000 or higher can be favorably used. When the amphiphilic compound is used as the binder, since affinity between the hydrophobic coating (a water-repellent resin or a transition metal oxide) of the coated positive electrode active material and the aqueous solvent (for example, water) increases, the positive electrode active material and the binder (amphiphilic compound) disperse favorably in the composition. Moreover, only one of the binders listed above may be used independently, or two or more of the binders may be used in combination with each other.

When a total amount of the positive electrode mixture layer (a non-volatile content in the composition or, in other words, a combined proportion of the coated positive electrode active material, the binder, the electrically conductive material, and the like in the composition) to be described later is assumed to be 100% by mass, an additive amount (content) of the binder is favorably within a range of approximately 2% by mass to 5% by mass (for example, approximately 2% by mass to 3% by mass). Adjusting the additive amount of the binder to within this range produces a lithium-ion secondary battery with superior cycling characteristics (low increase in resistance).

Next, the composition applying step will be described. The composition applying step involves applying the prepared composition to the positive electrode current collector.

As the positive electrode current collector, an electrically conductive member made of metal with good electrical conductivity can be favorably used in a similar manner to an electrode current collector that is used in a positive electrode of a conventional lithium-ion secondary battery. For example, an aluminum material or an alloy material mainly constituted by an aluminum material can be used. There are no particular limitations on the shape of the positive electrode current collector since the shape may vary in accordance with the shape and the like of the lithium-ion secondary battery, and various shapes may be adopted such as that of a rod, a plate, a sheet, a foil or a mesh.

Techniques similar to conventionally known methods may be appropriately adopted as a method of applying the composition. For example, the composition can be preferably applied to the surface of the positive electrode current collector using an appropriate coating applicator such as a gravure coater, a comma coater, a slit coater, and a die coater.

Subsequently, the composition applied to the positive electrode current collector is dried to remove the solvent and the positive electrode current collector is pressed (compressed) if necessary to form the positive electrode mixture layer. Accordingly, a positive electrode (for example, a sheet-shaped positive electrode) for a lithium-ion secondary battery comprising a positive electrode current collector and a positive electrode mixture layer formed on the positive electrode current collector can be fabricated.

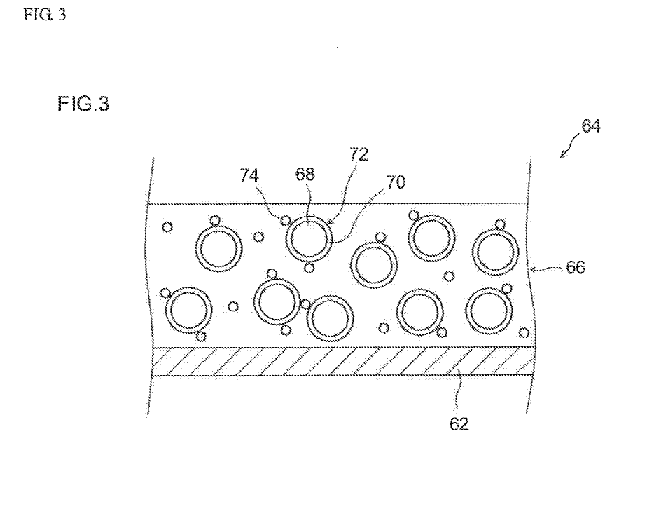

FIG. 3 is a sectional view schematically showing a structure of a positive electrode 64 according to an embodiment of the present invention. It should be noted that although an electrically conductive material may be included in a positive electrode mixture layer 66 of the positive electrode 64, the electrically conductive material is not shown for simplicity. As shown in FIG. 3, the positive electrode 64 according to the present embodiment comprises a positive electrode current collector 62 and a positive electrode mixture layer 66 formed on the current collector 62. The positive electrode mixture layer 66 includes a coated positive electrode active material 72, which is obtained by coating a surface of a positive electrode active material 68 with a hydrophobic coating 70, and a binder 74. While an aqueous solvent is used in a manufacturing process of the positive electrode mixture layer 66 according to the present embodiment, since the positive electrode active material 68 is coated by the hydrophobic coating 70, the positive electrode active material 68 and the aqueous solvent are prevented from coming into contact with each other. Therefore, even though the obtained positive electrode 64 is fabricated using an aqueous solvent, the positive electrode current collector 62 is capable of withstanding alkaline corrosion. In addition, when using an amphiphilic compound (for example, polyethylene oxide) as the binder 74, as shown in FIG. 3, a preferable dispersed arrangement of the coated positive electrode active material 72 may be realized in the positive electrode mixture layer 66.

On the other hand, a negative electrode that is the other electrode of the lithium-ion secondary battery can be fabricated according to a method similar to conventional methods. For example, one, two or more materials conventionally used in lithium-ion secondary batteries can be used without limitation for the negative electrode active material. Preferable examples of these materials include granular carbon materials (carbon particles) containing a graphite structure (layered structure) in at least a portion thereof. Carbon materials having a so-called graphitic structure (graphite), a non-graphitizable carbonaceous structure (hard carbon), a graphitizable carbonaceous structure (soft carbon) or a combination thereof are used preferably. For example, graphite particles such as natural graphite particles can be used preferably.

A paste-like negative electrode mixture layer forming composition can be prepared by dispersing such a negative electrode active material typically together with a binder (a binder similar to that used in the positive electrode mixture layer; for example, styrene butadiene rubber (SBR)) in an appropriate solvent (typically, water) and kneading the solvent. A negative electrode mixture layer is formed by applying an appropriate amount of this composition on a negative electrode current collector made of a copper material, a nickel material, or an alloy material mainly constituted by a copper material or a nickel material and then drying the composition. Accordingly, the negative electrode of the lithium-ion secondary battery comprising a negative electrode current collector and a negative electrode mixture layer formed on the negative electrode current collector can he fabricated.

Next, a step of constructing the lithium-ion secondary battery by housing the sheet-shaped positive electrode manufactured according to the method described above and the fabricated sheet-shaped negative electrode in a battery case together with an electrolyte solution will be described. A wound electrode body is fabricated by laminating and winding the positive electrode and the negative electrode together with two separator sheets. Next, the wound electrode body is housed in a battery case (for example, a flat cuboid case), and an electrolyte solution is poured into the battery case. Subsequently, an opening of the battery case is sealed by a lid body to construct the lithium-ion secondary battery. In this case, an electrolyte solution similar to non-aqueous electrolyte solutions conventionally used in lithium-ion secondary batteries can be used for the electrolyte solution without any particular limitations. This non-aqueous electrolyte solution typically has a composition in which a supporting salt is contained in a suitable non-aqueous solvent. For example, one, two or more non-aqueous solvents selected from EC, PC, DMC, DEC, EMC, and the like can be used. In addition, for example, a lithium salt such as LiPF₆ and LiBF₄ can be used as the supporting salt (supporting electrolyte). Furthermore, examples of the separator sheet include a separator sheet constituted by a porous polyolefin-based resin.

While a mode of the constructed lithium-ion secondary battery will now be described with reference to the drawings, the mode is not intended to limit the present invention thereto. In other words, a shape (external shape and size) of the constructed lithium-ion secondary battery is not particularly limited as long as the lithium-ion secondary battery comprises the positive electrode having the positive electrode mixture layer including at least the coated positive electrode active material obtained by coating a surface of the positive electrode active material with a hydrophobic coating and the binder which dissolves or disperses in an aqueous solvent. In the following embodiment, an example of a lithium-ion secondary battery configured such that a wound electrode body and an electrolyte solution are housed in a square battery case will be described.

It should be noted that, in the following drawings, members and portions that produce the same effects will be described using the same reference characters and overlapping descriptions may sometimes be omitted. In addition, dimensional relationships (length, width, thickness, and the like) shown in the respective drawings do not necessarily reflect actual dimensional relationships.

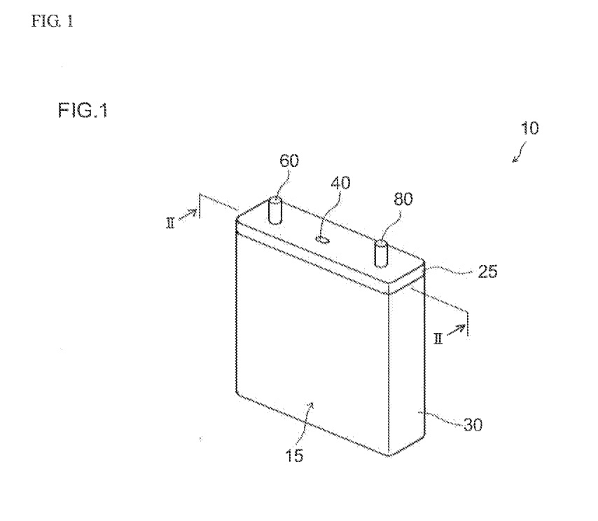

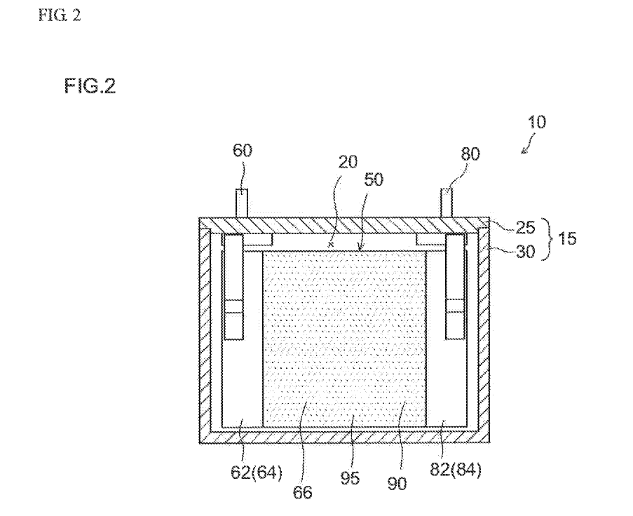

FIG. 1 is a perspective view schematically showing a lithium-ion secondary battery 10 according to the present embodiment. FIG. 2 is a vertical sectional view taken along line II-II in FIG. 1.

As shown in FIG. 1, the lithium-ion secondary battery 10 according to the present embodiment comprises a metal battery case 15 (a battery case 15 made of resin or a laminated film is also preferable). The case (outer container) 15 comprises a flat cuboid case main body 30 having an open upper end, and a lid body 25 that blocks the opening 20. The lid body 25 seals the opening 20 of the case main body 30 by welding or the like. A positive electrode terminal 60 which is electrically connected to a positive electrode (sheet-shaped positive electrode) 64 of a wound electrode body 50 and a negative electrode terminal 80 which is electrically connected to a negative electrode (sheet-shaped negative electrode) 84 of the electrode body are provided on an upper surface (in other words, the lid body 25) of the case 15. In addition, the lid body 25 is provided with a safety valve 40 for purging gas, created inside the case 15 during battery failure, to the exterior of the case 15 in a similar manner to cases of conventional lithium-ion secondary batteries. Housed inside the case 15 is the flat-shaped wound electrode body 50 fabricated by laminating and winding the positive electrode 64 and the negative electrode 84 together with two separator sheets 95 and subsequently squashing an obtained wound body in a direction of a side surface thereof and the electrolyte solution described above.

When laminating, as shown in FIG. 2, the positive electrode 64 and the negative electrode 84 are overlapped while being slightly displaced in a width direction of the separator sheets 95 so that a positive electrode mixture layer unformed section (in other words, a portion in which a positive electrode mixture layer 66 is not formed and a positive electrode current collector 62 is exposed) of the positive electrode 64 and a negative electrode mixture layer unformed section (in other words, a portion in which a negative electrode mixture layer 90 is not formed and a negative electrode current collector 82 is exposed) of the negative electrode 84 respectively protrude from either side in the width direction of the separator sheets 95. As a result, the electrode mixture layer unformed sections of the positive electrode 64 and the negative electrode 84 respectively protrude outward from a wound core portion (in other words, a portion in which the positive electrode mixture layer unformed section of the positive electrode 64, the negative electrode mixture layer unformed section of the negative electrode 84, and the two separator sheets 95 are tightly laminated) in a direction lateral with respect to a winding direction of the wound electrode body 50. The positive electrode terminal 60 is joined to the positive electrode-side protruding portion to electrically connect the positive electrode 64 of the wound electrode body 50 formed in a flat shape and the positive electrode terminal 60 with each other. In a similar manner, the negative electrode terminal 80 is joined to the negative electrode-side protruding portion to electrically connect the negative electrode 84 and the negative electrode terminal 80 with each other. Moreover, the positive and negative electrode terminals 60 and 80 and the positive and negative electrode current collectors 62 and 82 can be respectively joined by ultrasonic welding, resistance welding, and the like.

While test examples relating to the present invention will be described below it is to be understood that the present invention is not intended to be limited by the contents indicated in the following test examples.

### TEXT EXAMPLE 1

### Performance Evaluation of Paste-Like Composition

### EXAMPLE 1-1

100 parts by mass of Li_{1.05}Ni_{0.75}Co_{0.1}Mn_{0.1}Al_{0.05}O₂ (hereinafter, abbreviated as LNO) as a positive electrode active material and 2 parts by mass of polyvinylidene fluoride (PVDF) as a hydrophobic coating (a water-repellent resin) were added to NMP and kneaded by a planetary mixer to prepare a paste-like mixture (with a solid content concentration of approximately 10% by mass) The paste-like mixture was then dried for 10 hours at 120° C. in a reduced-pressure atmosphere. After drying, the dried aggregate was lightly crushed in a mortar to fabricate a PVDF-coated positive electrode active material (a coated positive electrode active material) in which a surface of LNO is coated by PVDF (the hydrophobic coating).

The fabricated PVDF-coated positive electrode active material, acetylene black (AB) as an electrically conductive material, and polyethylene oxide powder (mass-average molecular weight: 500,000) as a binder were weighed so as to assume a mass ratio 92:5:3. The materials were dispersed in deionized water to prepare a paste-like positive electrode mixture layer forming composition according to Example 1-1.

### EXAMPLE 1-2

A paste-like positive electrode mixture layer forming composition according to Example 1-2 was prepared in a similar manner to Example 1-1 with the exception of using PVDF as a binder.

### EXAMPLE 1-3

LNO as the positive electrode active material, AB as the electrically conductive material, and polyethylene oxide (PEO) as the binder were weighed so as to assume a mass ratio 92:5:3, and the materials were then dispersed in ion-exchanged water to prepare a paste-like positive electrode mixture layer forming composition according to Example 1-3.

### EXAMPLE 1-4

A paste-like positive electrode mixture layer forming composition according to Example 1-4 was prepared in a similar mariner to Example 1-3 with the exception of using PVDF as a binder.

<Composition Viscosity Measurement Test>

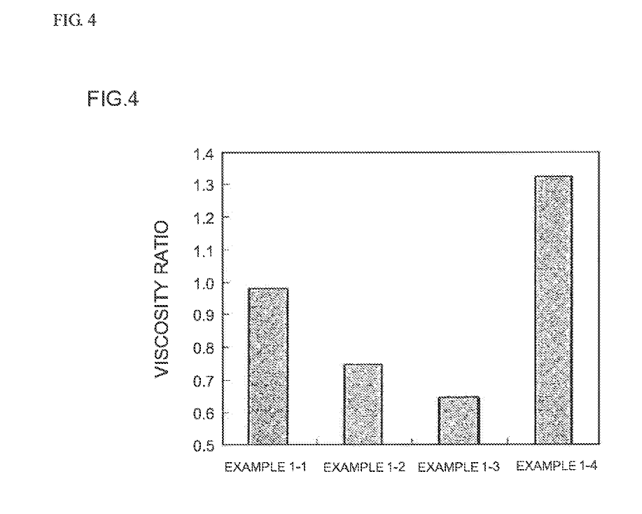

Viscosity ratios of the compositions according to Examples 1-1 to 1-4 were measured using a Brookfield viscometer. Specifically, viscosity after preparation (initial viscosity) of the compositions according to the respective examples were measured at normal temperature (typically, around 25° C.) and at a revolving speed of 20 rpm, and after allowing the compositions to stand at normal temperature for 24 hours, viscosity after the lapse of 24 hours (viscosity after 24 hours) of the compositions according to the respective examples were measured. A ratio of the viscosity after 24 hours to the initial viscosity (viscosity after 24 hours/initial viscosity) was taken as the viscosity ratio. Measurement results are shown in FIG. 4 and Table 1.

TABLE 1

| | Hydrophobic | | | |
|---|---|---|---|---|
| | coating | | | |
| | (water-repellent | | | |
| Examples | resin: PVDF) | Binder | Viscosity ratio | Resistance ratio |
| Example 1-1 | Applied | PEO | 0.98 | 1.05 |
| Example 1-2 | Applied | PVDF | 0.75 | 1.3 |
| Example 1-3 | Not applied | PEO | 0.65 | 1.5 |
| Example 1-4 | Not applied | PVDF | 1.32 | 1.35 |

As shown in FIG. 4 and Table 1, it was confirmed that compositions in which the surface of the positive electrode active material (LNO) is coated by the hydrophobic coating (the water-repellent resin) has a smaller viscosity variation compared to uncoated compositions. In particular, the composition using amphiphilic polyethylene oxide as the binder as is the ease of Example 1-1 was confirmed to be a stable composition with hardly any variation in viscosity. Moreover, conceivably, the composition according to Example 1-3 has reduced viscosity due to decomposition of the binder (PEO) under strong alkaline, while the composition according to Example 1-4 has increased viscosity due to gelation of the binder (PVDF) under strong alkaline.

<Performance Evaluation of Lithium-Ion Secondary Battery>

The paste-like positive electrode mixture layer forming composition according to Example 1-1 was applied on a positive electrode current collector (aluminum foil) with a thickness of around 15 μm at an application quantity of 6 mg/cm² per one surface and dried, and subsequently subjected to a roll press process to fabricate a positive electrode sheet according to Example 1-1 in which a positive electrode mixture layer is formed on the positive electrode current collector.

On the other hand, scale-like graphite as a negative electrode active material, styrene butadiene rubber (SBR) as a binder, and carboxymethyl cellulose (CMC) as a thickener were weighed so as to assume a mass ratio 98:1:1, and the materials were then dispersed in deionized water to prepare a paste-like negative electrode mixture layer forming composition. The composition was applied on a negative electrode current collector (copper foil) with a thickness of around 10 μm at an application quantity of 4 mg/cm² per one surface and dried, and subsequently subjected to a roll press process to fabricate a negative electrode sheet according to Example 1-1 in which a negative electrode mixture layer is formed on the negative electrode current collector.

Next, a 3 cm×4 cm square was punched out from the positive electrode mixture layer of the positive electrode sheet to fabricate a positive electrode. In addition, a 3 cm×4 cm square was punched out from the negative electrode mixture layer of the negative electrode sheet to fabricate a negative electrode. An aluminum lead was attached to the positive electrode, a nickel lead was attached to the negative electrode, the positive electrode and the negative electrode were arranged (laminated) so as to oppose each other across a separator sheet (a polypropylene-polyethylene-polypropylene complex porous film) and housed in a laminated case (laminated film) together with an electrolyte solution to construct a lithium-ion secondary battery according to Example 1-1. An electrolyte solution obtained by dissolving 1 mol/L of LiPF₆ in a mixed solvent containing ethylene carbonate (EC), ethyl methyl carbonate (EMC), and dimethyl carbonate (DMC) at a volume ratio of 4:3:3 was used. In addition, batteries were constructed in a similar manner to the lithium-ion secondary battery according to Example 1-1 using the compositions according to Examples 1-2 to 1-4.

<Resistance Measurement Test>

First, an initial resistance was measured for the constructed lithium-ion secondary battery according to Example 1-1. Specifically, after adjusting to a state of charge of SOC 60%, a 10-second constant current discharge was performed at 10 C under a −15° C. temperature condition, whereby an initial resistance was obtained from an inclination of a first-order approximation straight line of current (I)-voltage (V) plot values at this point.

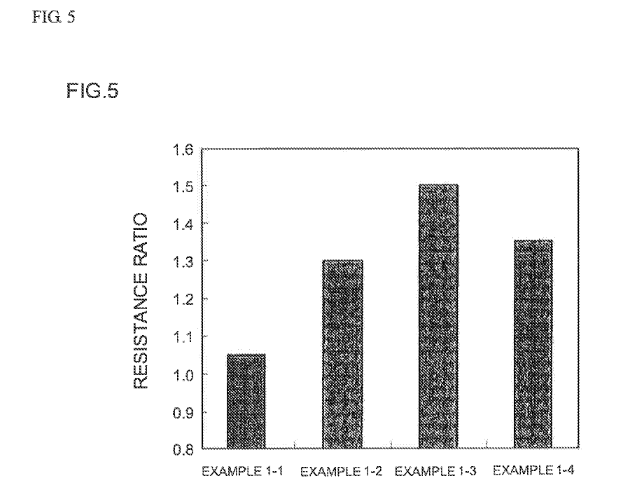

Next, charge and discharge were repetitively performed for 1000 cycles on the lithium-ion secondary battery according to Example 1-1 after the initial resistance measurement, and a resistance after 1000 cycles was measured. Charge and discharge conditions per cycle involved charging according to a CC/CV method at 2 C under a 25° C. temperature condition to an upper limit voltage of 4.1 V and performing CC discharge at 2 C to a lower limit voltage of 3.3 V The resistance after 1000 cycles was obtained for the lithium-ion secondary battery after 1000 cycles according to as method similar to that used when measuring the initial resistance. At this point, a ratio of the resistance after 1000 cycles to the initial resistance (resistance after 1000 cycles/initial resistance) was taken as the resistance ratio. In a similar manner, resistance ratios were measured for the lithium-ion secondary batteries according to Examples 1-2 to 1-4. Measurement results are shown in FIG. 5 and Table 1.

As shown in FIG. 5 and Table 1, it was confirmed that lithium-ion secondary batteries comprising a positive electrode active material coated by the hydrophobic coating (the water-repellent resin) has a smaller resistance variation (in other words, an increase in resistance) after 1000 cycles as compared to lithium-ion secondary batteries comprising an uncoated positive electrode active material. In particular, the lithium-ion secondary battery using amphiphilic polyethylene oxide as the binder as is the case of Example 1-1 was confirmed to be a lithium-ion secondary battery with superior cycling characteristics and with hardly any variation in resistance even after repetitively performing charge and discharge for 1000 cycles.

<Performance Evaluation of Binder>

With the lithium-ion secondary battery according to Example 1-1, while the content of the binder in the positive electrode mixture layer was 3% by mass, a variation of the resistance ratio of the lithium-ion secondary battery due to the content of the binder was measured. In this case, seven lithium-ion secondary batteries from Examples 2-1 to 2-7 were prepared.

A lithium-ion secondary battery according to Example 2-1 was constructed in a similar manner to Example 1-1 with the exception of using a paste-like positive electrode mixture layer forming composition in which the PVDF-coated positive electrode active material according to Example 1-1, AB, and polyethylene oxide (PEO) assumed a mass ratio of 94:5:1. In addition, lithium-ion secondary batteries according to Examples 2-2 to 2-7 were constructed in a similar manner to the battery according to Example 2-1. Mass ratios of the PVDF-coated positive electrode active material (coated positive electrode active material), AB, and polyethylene oxide (PEO) in the respective examples are shown in Table 2.

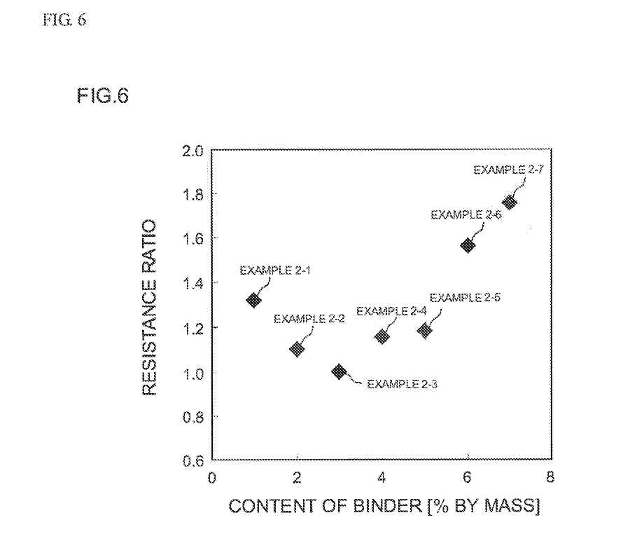

Resistance ratios were measured for the constructed lithium-ion secondary batteries according to Examples 2-1 to 2-7 under the same conditions as the resistance measurement test performed on the respective secondary batteries according to Examples 1-1 to 1-4. Measurement results are shown in FIG. 6 and Table 2.

TABLE 2

| | Positive electrode | | | |
|---|---|---|---|---|
| | active material | AB | PEO | Resistance |
| Examples | [% by mass] | [% by mass] | [% by mass] | ratio |
| Example 2-1 | 94 | 5 | 1 | 1.32 |
| Example 2-2 | 93 | 5 | 2 | 1.1 |
| Example 2-3 | 92 | 5 | 3 | 1 |
| Example 2-4 | 91 | 5 | 4 | 1.15 |
| Example 2-5 | 90 | 5 | 5 | 1.18 |
| Example 2-6 | 89 | 5 | 6 | 1.56 |
| Example 2-7 | 88 | 5 | 7 | 1.75 |

As shown in FIG. 6 and Table 2, the lithium-ion secondary battery with a binder content of 1% by mass exhibited an increase in resistance ratio. In addition, lithium-ion secondary batteries with a binder content of 6% by mass or more exhibited a significant increase in resistance ratio. On the other hand, lithium-ion secondary batteries with a binder content ranging from 2% by mass to 5% by mass had low resistance ratios of 1.2 or lower. In particular, the lithium-ion secondary battery with a binder content of 3% by mass exhibited hardly any variation in resistance ratio, thereby confirming that cycling characteristics have been favorably improved.

### TEXT EXAMPLE 2

### Performance Evaluation of Paste-Like Composition

### EXAMPLE 3-1

100 parts by mass of LNO as a positive electrode active material and 3 parts by mass of tungsten oxide nanopowder (WO₃) as a hydrophobic coating (a transition metal oxide) were placed in a bench-top bail mill and subjected to a mechanochemical process (500 rpm, 1 hour) to fabricate a WO₃-coated positive electrode active material (coated positive electrode active material) in which a surface of the LNO is coated by WO₃. The positive electrode active material (LNO) had a BET specific surface area of 0.5 m²/g as measured in accordance with JIS K1477 (JIS Z 8830).

The fabricated WO₃-coated positive electrode active material, AB as an electrically conductive material, and PEO as a binder were weighed so as to assume a mass ratio 92:5:3. The materials were then dispersed in deionized water to prepare a paste-like positive electrode mixture layer forming composition according to Example 3-1.

### EXAMPLE 3-2

A paste-like positive electrode mixture layer forming composition according to Example 3-2 was prepared in a similar manner to Example 3-1 with the exception of using PVDF as a binder.

### EXAMPLE 3-3

LNO as the positive electrode active material, AB as the electrically conductive material, and PEO as the binder were weighed so as to assume a mass ratio 92:5:3, and the materials were then dispersed in deionized water to prepare a paste-like positive electrode mixture layer forming composition according to Example 3-3.

### EXAMPLE 3-4

A paste-like positive electrode mixture layer forming composition according to Example 3-4 was prepared in a similar manner to Example 3-3 with the exception of using PVDF as a binder.

<Composition Viscosity Measurement Test>

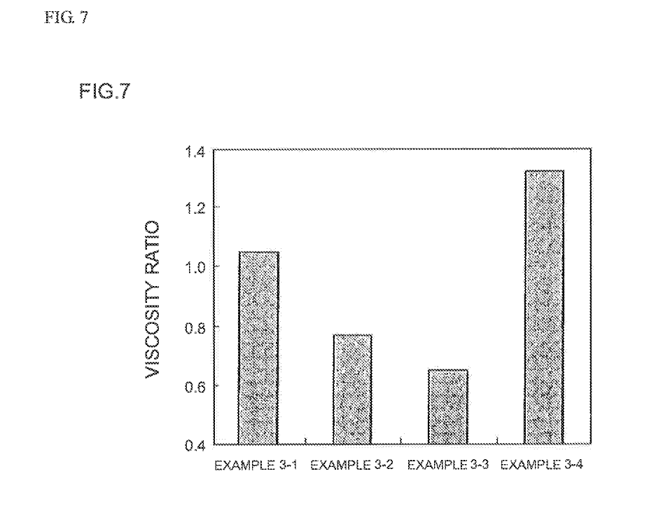

Viscosity ratios were measured for the prepared compositions according to Examples 3-1 to 3-4 under the same conditions as the viscosity measurement test performed on the respective compositions according to Examples 1-1 to 1-4. Measurement results are shown in FIG. 7 and Table 3.

TABLE 3

| | Hydrophobic | | | |
|---|---|---|---|---|
| | coating | | | |
| | (transition metal | | | Resistance |
| Examples | oxide: WO₃) | Binder | Viscosity ratio | ratio |
| Example 3-1 | Applied | PEO | 1.65 | 1 |
| Example 3-2 | Applied | PVDF | 0.77 | 1.2 |
| Example 3-3 | Not applied | PEO | 0.65 | 1.78 |
| Example 3-4 | Not applied | PVDF | 1.32 | 1.65 |

As shown in FIG. 7 and Table 3, it was confirmed that compositions in which the surface of the positive electrode active material (LNO) is coated by the hydrophobic coating (the transition metal oxide) has a smaller viscosity variation compared to uncoated compositions. In particular, the composition using amphiphilic polyethylene oxide as the binder as is the case of Example 3-1 was confirmed to be a stable composition with hardly any variation in viscosity.

<Performance Evaluation of Lithium-Ion Secondary Battery>

A lithium-ion secondary battery according to Example 3-1 was constructed in a similar manner to Example 1-1 with the exception of using the composition according to Example 3-1. In addition, batteries were constructed in a similar manner to the lithium-ion secondary battery according to Example 3-1 using the compositions according to Examples 3-2 to 3-4.

<Resistance Measurement Test>

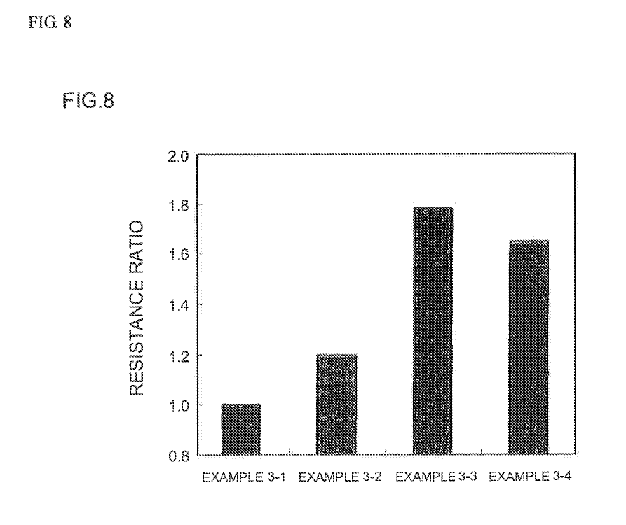

Resistance ratios were measured for the constructed lithium-ion secondary batteries according to Examples 3-1 to 3-4 under the same conditions as the resistance measurement test performed on the respective secondary batteries according to Examples 1-1 to 1-4. Measurement results are shown in FIG. 8 and Table 3.

As shown in FIG. 8 and Table 3, it was confirmed that lithium-ion secondary batteries comprising a positive electrode active material coated by the hydrophobic coating (the transition metal oxide) has a smaller resistance variation (in other words, an increase in resistance) after 1000 cycles as compared to lithium-ion secondary batteries comprising an uncoated positive electrode active material. In particular, the lithium-ion secondary battery using amphiphilic polyethylene oxide as the binder as is the case of Example 3-1 was confirmed to be a lithium-ion secondary battery with superior cycling characteristics and with hardly any variation in resistance even after repetitively performing charge and discharge for 1000 cycles.

<Performance Evaluation of Coated Positive Electrode Active Material>

### EXAMPLE 4-1

100 g of LNO having a BET specific surface area X of 1.5 m²/g as measured in accordance with JIS K1477 (JIS Z 8830) and 150 mg of WO₃ were placed in a bench-top ball mill and then subjected to a mechanochemical process (500 rpm, 1 hour) to fabricate a WO₃-coated positive electrode active material (coated positive electrode active material) in which a surface of the LNO is coated by WO₃. When a ratio A/B between a mass A [mg] of WO₃ and a mass B [g] of LNO was assumed to be an oxide-coated amount (WO₃-coated amount) Y [mg/g], Y/X was 1 mg/m².

The fabricated WO₃-coated positive electrode active material, AB, and PEO were weighed so as to assume a mass ratio 92:5:3, and the materials were then dispersed in deionized water to prepare a paste-like positive electrode mixture layer forming composition according to Example 4-1. A lithium-ion secondary battery according to Example 4-1 was constructed in a similar manner to Example 1-1 with the exception of using the composition according to Example 4-1.

### EXAMPLE 4-2

A lithium-ion secondary battery according to Example 4-2 was constructed in a similar manner to Example 4-1 with the exception of using 100 g of LNO having a BET specific surface area X [m²/g] of 1 m²/g and 200 mg of WO₃. In this case, Y/X was 2 mg/m².

### EXAMPLE 4-3

A lithium-ion secondary battery according to Example 4-3 was constructed in a similar manner to Example 4-1 with the exception of using 100 g of LNO having a BET specific surface area X [m²/g] of 1 m²/g and 500 mg of WO₃. In this case, Y/X was 5 mg/m².

### EXAMPLE 4-4

A lithium-ion secondary battery according to Example 4-4 was constructed in a similar manner to Example 4-1 with the exception of using 100 g of LNO having a BET specific surface area X [m²/g] of 0.8 m²/g and 800 mg of WO₃. In this case, Y/X was 10 mg/m².

### EXAMPLE 4-5

A lithium-ion secondary battery according to Example 4-5 was constructed in a similar manner to Example 4-1 with the exception of using 100 g of LNO having a BET specific surface area X [m²/g] of 0.8 m²/g and 1600 mg of WO₃. In this case, Y/X was 20 mg/m².

### EXAMPLE 4-6

A lithium-ion secondary battery according to Example 4-6 was constructed in a similar manner to Example 4-1 with the exception of using 100 g of LNO having a BET specific surface area X [m²/g] of 0.8 m²/g and 3200 mg of WO₃. In this case, Y/X was 40 mg/m².

### EXAMPLE 4-7

A lithium-ion secondary battery according to Example 4-7 was constructed in a similar manner to Example 4-1. with the exception of using 100 g of LNO having a BET specific surface area X [m²/g] of 0.6 m²/g and 3000 mg of WO₃. In this case, Y/X was 50 mg/m².

### EXAMPLE 4-8

A lithium-ion secondary battery according to Example 4-8 was constructed in a similar manner to Example 4-1 with the exception of using 100 g of LNO having a BET specific surface area X [m²/g] of 0.6 m²/g and 4800 mg of WO₃. In this case, Y/X was 80 mg/m².

### EXAMPLE 4-9

A lithium-ion secondary battery according to Example 4-9 was constructed in a similar manner to Example 4-1 with the exception of using 100 g of LNO having a BET specific surface area X [m²/g] of 0.4 m²/g and 4200 mg of WO₃. In this case, Y/X was 105 mg/m².

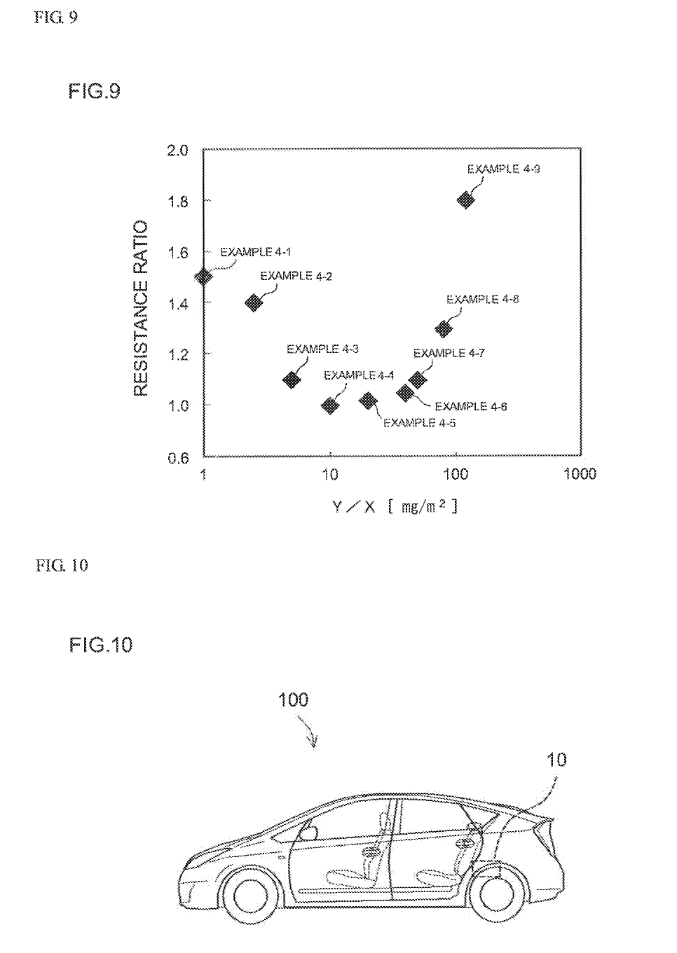

Resistance ratios were measured for the constructed lithium-ion secondary batteries according to Examples 4-1 to 4-9 under the same conditions as the resistance measurements performed on the respective secondary batteries according to Examples 1-1 to 1-4. Measurement results are shown in FIG. 9 and Table 4.

TABLE 4

| | BET specific | | | |
|---|---|---|---|---|
| | surface | Oxide-coated | Y/X | Resistance |
| Examples | area X [m²/g] | amount Y [mg/g] | [mg/m²] | ratio |
| Example 4-1 | 1.5 | 1.5 | 1 | 1.5 |
| Example 4-2 | 1 | 2 | 2 | 1.38 |
| Example 4-3 | 1 | 5 | 5 | 1.12 |
| Example 4-4 | 0.8 | 8 | 10 | 1 |
| Example 4-5 | 0.8 | 16 | 20 | 1.04 |
| Example 4-6 | 0.8 | 32 | 40 | 1.07 |
| Example 4-7 | 0.6 | 30 | 50 | 1.11 |
| Example 4-8 | 0.6 | 48 | 80 | 1.25 |
| Example 4-9 | 0.4 | 42 | 105 | 1.8 |

As shown in FIG. 9 and Table 4, lithium-ion secondary batteries where Y/X was smaller than 5 mg/m² exhibited a significant increase in the resistance ratio (an increase in resistance). In addition, lithium-ion secondary batteries where Y/X was greater than 50 mg/m² also exhibited a significant increase in the resistance ratio. On the other hand, lithium-ion secondary batteries where Y/X ranged from 5 mg/m² to 50 mg/m² had low resistance ratios of 1.1 or lower. In particular, lithium-ion secondary batteries where Y/X ranged from 10 mg/m² to 40 mg/m² (more favorably ranged from 10 mg/m² to 20 mg/m²) exhibited hardly any variation in resistance ratio, thereby confirming that cycling characteristics have been favorably improved.

While specific examples of the present invention have been described in detail, such specific examples are merely illustrative and are not intended to limit the scope of claims. It is to be understood that the techniques described in the scope of claims include various modifications and changes made to the specific examples illustrated above.

### INDUSTRIAL APPLICABILITY

Since the lithium-ion secondary battery 10 according to the present invention is capable of achieving lower environmental impact during a manufacturing process thereof and has superior cycling characteristics, the lithium-ion secondary battery 10 can be used in various applications. For example, as shown in FIG. 10, the lithium-ion secondary battery 10 can be preferably used as a power source of a vehicle-driving motor (an electric motor) to be mounted to a vehicle 100 such as an automobile. Although the vehicle 100 is not limited to any particular type, the vehicle 100 is typically a hybrid automobile, an electrical automobile, a fuel cell automobile, or the like. The lithium-ion secondary battery 10 may be used independently or used in a mode of an assembled battery in which a plurality of the lithium-ion secondary batteries 10 are connected in series and/or in parallel.

### REFERENCE SIGNS LIST

10 lithium-ion secondary battery
15 battery case
20 opening
25 lid body
30 case main body
40 safety valve
50 wound electrode body
60 positive electrode terminal
62 positive electrode current collector
64 positive electrode (sheet-shaped positive electrode)
66 positive electrode mixture layer
68 positive electrode active material
70 hydrophobic coating
72 coated positive electrode active material
74 binder
80 negative electrode terminal
82 negative electrode current collector
84 negative electrode (sheet-shaped negative electrode)
90 negative electrode mixture layer
95 separator sheet
100 vehicle (automobile)

1. A lithium-ion secondary battery comprising a positive electrode and a negative electrode, wherein
the positive electrode has a positive electrode current collector and a positive electrode mixture layer which is formed on the current collector and which includes at least a positive electrode active material and a binder,
a surface of the positive electrode active material is coated by a hydrophobic coating, and
the binder is an amphiphilic compound that dissolves or disperses in an aqueous solvent.

2. (canceled)

3. The lithium-ion secondary battery according to claim 1, wherein the amphiphilic compound is polyethylene oxide.

4. The lithium-ion secondary battery according to claim 1, wherein when the positive electrode mixture layer is assumed to be 100% by mass, the binder is included in the positive electrode mixture layer in a proportion of 2% by mass to 5% by mass.

5. The lithium-ion secondary battery according to claim 1, wherein the hydrophobic coating is formed of a water-repellent resin.

6. The lithium-ion secondary battery according to claim 5, wherein the water-repellent resin is a fluorine-based resin.

7. The lithium-ion secondary battery according to claim 1, wherein the hydrophobic coating is formed of a transition metal oxide.

8. The lithium-ion secondary battery according to claim 7, wherein the transition metal oxide is tungsten oxide or zirconium oxide.

9. The lithium-ion secondary battery according to claim 7, wherein a surface of the positive electrode active material is coated by a hydrophobic coating constituted by the transition metal oxide, and when the positive electrode active material is assumed to have a BET specific surface area of X [m²/g] and A/B, which is a ratio between a mass A [mg] of the transition metal oxide and a mass B [g] of the positive electrode active material, is assumed to be an oxide-coated amount Y [mg/g], Y/X has a value of 5 mg/m² to 50 mg/m².

10. The lithium-ion secondary battery according to claim 1, wherein the positive electrode active material is a lithium-nickel complex oxide represented by the general formula:
Li₁₊ₓ(Ni_{y}Co_{z}Mn_{1-y-z-γ}M_{γ})O₂
(where 0≦x≦0.2, 0.5≦y≦1, 0≦z≦0.5, 0≦γ≦0.2, 0.5≦y+z+γ≦1, and M is at least one element selected from the group including F, B, Al, W, Mo, Cr, Ta, Nb, V, Zr, Ti, and Y).

11. A method of manufacturing a lithium-ion secondary battery, comprising:
a step of forming a positive electrode having a positive electrode mixture layer including a positive electrode active material on a positive electrode current collector; a step of forming a negative electrode having a negative electrode mixture layer including a negative electrode active material on a negative electrode current collector; and a step of combining the formed positive electrode and the formed negative electrode to form an electrode body, wherein
the positive electrode forming step comprises:
preparing a coated positive electrode active material by coating a surface of the positive electrode active material with a hydrophobic coating;
preparing a paste-like positive electrode mixture layer forming composition resulting from adding at least the coated positive electrode active material and a binder, which dissolves or disperses into an aqueous solvent, to an aqueous solvent and kneading the same; and
applying the prepared positive electrode mixture layer forming composition to a surface of the positive electrode current collector.

12. The manufacturing method according to claim 11, wherein an amphiphilic compound is used as the binder.

13. The manufacturing method according to claim 12, wherein polyethylene oxide is used as the amphiphilic compound.

14. The manufacturing method according to claim 11, wherein when the formed positive electrode mixture layer is assumed to be 100% by mass, the paste-like positive electrode mixture layer forming composition is prepared so that the binder is included in the positive electrode mixture layer in a proportion of 2% by mass to 5% by mass.

15. The manufacturing method according to claim 11, wherein a coated positive electrode active material, in which a surface of the positive electrode active material is coated by a water-repellent resin as the hydrophobic coating, is used as the coated positive electrode active material.

16. The manufacturing method according to claim 15, wherein the water-repellent resin is a fluorine-based resin.

17. The manufacturing method according to claim 11, wherein a coated positive electrode active material, in which a surface of the positive electrode active material is coated by a transition metal oxide as the hydrophobic coating, is used as the coated positive electrode active material.

18. The manufacturing method according to claim 17, wherein the transition metal oxide is tungsten oxide or zirconium oxide.

19. The manufacturing method according to claim 17, wherein a coated positive electrode active material is used, where Y/X has a value of 5 mg/m² to 50 mg/m² when the positive electrode active material is assumed to have a BET specific surface area of X [m²/g] and A/B, which is a ratio between a mass A [mg] of the transition metal oxide and a mass B [g] of the positive electrode active material, is assumed to be an oxide-coated amount Y [mg/g].

20. The manufacturing method according to claim 11, wherein a lithium-nickel complex oxide represented by the general formula:
Li₁₊ₓ(Ni_{y}CO_{z}Mn_{1-y-z-γ}M_{γ})O₂
(where 0≦x≦0.2, 0.5≦y≦1, 0≦z≦0.5, 0≦γ0.2, 0.5≦y+z+γ≦1, and M is at least one element selected from the group including F, B, Al, W, Mo, Cr, Ta, Nb, V, Zr, Ti, and Y) is used as the positive electrode active material.
